(19) United States
(12) Patent Application Publication
(10) Pub. No.: US 2007/0019225 A1
(43) Pub. Date: Jan. 25, 2007

(54) Job length informer for printer

(75) Inventor: Anthony H. Digby, Widmer End (GB)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: XEROX CORPORATION

(21) Appl. No.: 11/184,374

(22) Filed: Jul. 19, 2005

(51) Int. Cl. G06F 3/12; G06K 15/00

(52) U.S. Cl. 358/1.14; 358/1.16; 358/1.1

(57) ABSTRACT

A method for displaying an amount of time remaining for a print job on a printer includes determining a time remaining for a print job, and displaying the time remaining for the print job on a display of a printer. The printer includes a printing module, a processor and a time remaining display.

### BACKGROUND

Many a user approaches a copier and finds that the copier is running a copy job but that no one is near the copier to say how long the job will take. The choice for the user is to stand and wait for the copier to complete the copy job or to go to another copier. The dilemma is that by the time another copier is found, the first copier may have finished the copy job and become usable.

Copiers, and for that matter other printers, which will be further described below, fail to include a display that indicates the time to finish for a print job.

### BRIEF SUMMARY

According to aspects illustrated herein, there is provided a method for displaying an amount of time remaining for a print job. The method includes determining a time remaining for a print job, and displaying the time remaining for the print job on a display of a printer.

According to other aspects illustrated herein, there is provided a method for displaying an amount of time remaining for a print job. The method includes receiving job specification input for a print job to be performed by the printer; receiving a number of original documents into the printer; determining the number of copy sheets that are to travel through the printer based on the job specification input and the number of original documents received by the printer; calculating a time for a copy sheet to travel through the printer based on the job specification input; calculating a total time for the print job based on the time calculated for the copy sheet to travel through the printer and the number of copy sheets that are to travel through the printer; initializing time remaining from the total time; displaying the time remaining on a display of the printer; and counting down the time remaining, whereby the time remaining is updated.

According to other aspects illustrated herein, there is provided a printer comprising a printing module, a processor, and a time remaining display in communication with the processor.

### BRIEF DESCRIPTION OF THE DRAWINGS

FIG. 1 is a block diagram of a printer.

FIG. 2 is a flow diagram of a method for displaying an amount of time remaining for a print job.

FIG. 3 is a flow diagram of a method for determining an amount of time remaining for a print job.

### DETAILED DESCRIPTION

The word “printer” as used herein encompasses any apparatus, such as a digital copier, bookmaking machine, facsimile machine, multi-function machine, etc. that performs a print outputting function. In the depicted embodiment, the printer 10 includes a printing module 14 and a processor 16 that is in communication with components of the printing module as well as other components of the printer. The printing module includes a document feeder 18, a display panel 20, an image reading device 24, and an image forming device 26. The document feeder 18 feeds original documents to the image reading device 24. The printer 10 can also receive electronic documents, for example documents that are produced by word processing programs, imaging software (e.g. Adobe® documents) and the like.

The display panel 20 displays information to the operator of the printer 10 and can also receive input from the operator. The display panel 20 can also dispay the amount of time remaining for a print job, which will be described in more detail below. Using the display panel 20, or another interface, the user can input job specification input for a particular print job. The job specification input can include whether the print job includes any stapling, collating, duplexing, binding, and the like.

In an embodiment of the printer 10, the image reading device 24 typically illuminates the original document delivered by the document feeder 18 and the resulting reflection from the original document is transformed to a corresponding electric signal, or image signal, by a solid state imaging device, e.g., a CCD (Charge Coupled Device) image sensor. In another embodiment of the printer, electronic documents can be transformed into a corresponding signal, for example via software on the processor 16. The image forming device 26 forms an image represented by the image signal on a plain paper, velum or a thermosensitive paper by an electrophotographic, thermosensitive, heat transfer, ink jet or similar conventional system.

The printing module can also include a plurality of media cassettes 28, e.g. paper trays, that store media, e.g. paper, velum. The media, which will be referred to as copy sheets, are fed to the image reading device 24 via a media transport system (not shown) that includes a plurality of rollers and other media handling equipment. Toner and/or colorants are stored in cartridges 32, and the like, and are deposited on the media to form an image. The printing module can include other media handling devices, such as a duplex copy unit (not shown), as well as software, e.g. an operating system (OS), that can be located on the processor 16 of the printer 10.

The processor 16 can communicate with and/or include a system status module 34 that monitors the operation of the printer 10 to detect for system faults and warnings, such as paper jams, low toner warnings, low paper warnings, out of staple fault, output tray full status and the like. For example, the system status module 16 can communicate with a jam detection system 36 that is incorporated into the printer. The jam detection system includes a plurality of sensors and/or switches that communicate with the processor 16. The sensors and/or switches detect a copy sheet, for example, as it moves along the media transport system. If the copy sheet fails to travel between sensors within a predetermined amount of time, the jam detection system can indicate that a paper jam has occurred. In such an instance, the jam detection system 36 can communicate with the system status module 34 and/or the processor 16.

The system status module 34 can also communicate with other sensors and detection systems, for example a paper tray quantity detection system that detects when a paper tray is low, a toner detection system that detects when the toner and/or colorant is low or needs to be replaced, a stapler detection system that detects when the printer is low on or out of staples, and an output tray detection system that indicates when an output tray should be emptied. The system status module 34 can also communicate with other detection systems that detect for conditions that would impact the operation of the printer.

As mentioned above, the jam detection system 36 measures the amount of time (travel time) that a copy sheet travels between sensors located along the media transport system. This travel time can also factor in variations in line voltage, copy sheet weight, humidity, wear, etc. Since the travel time between sensors is known or can be determined, the time for one copy sheet to travel through the media transport system, e.g. from the media cassette 28 to the output tray (not shown), can be determined, for example by summing the travel time between adjacent sensors along the media transport system. By factoring in the job specification input, for example collating, duplexing, stapling, binding, etc., additional time can be added to the time for a copy sheet to travel through the printer to determine a total nominal time for a copy sheet for a specific print job based on the job input specification. Based on the number of original documents, which can include electronic documents that have been delivered to the printer, and the total number of copy sheets to be produced by the printer, a total nominal time for a print job can be determined.

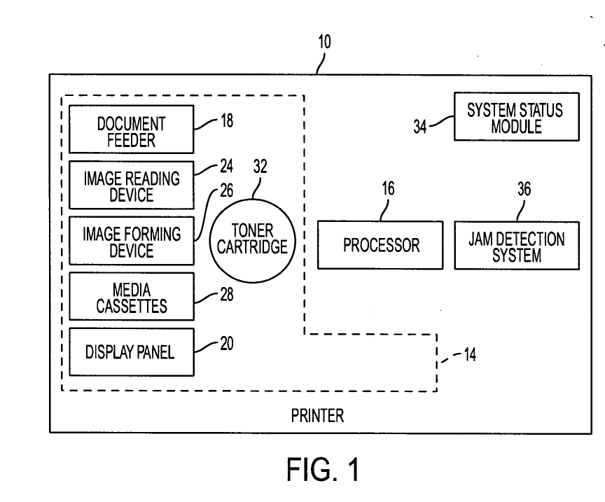

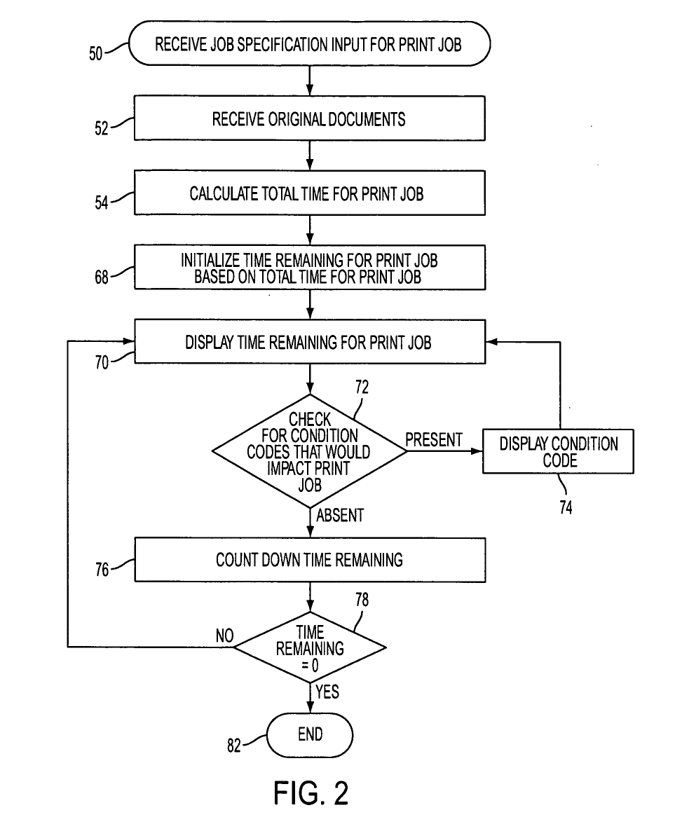

With reference to FIG. 2, a method for displaying an amount of time remaining for a print job is disclosed. At 50, the printer 10 (FIG. 1) receives job specification input for a print job via the display panel 20 (FIG. 1) or other user interface. The job specification input can include the number of copies that are to be produced, which would correspond to the number of copy sheets that are to travel through the printer. The job specification input can also include whether the copies are to be stapled or collated, whether the copies are to be single sided or double sided, as well as other operations that can be performed by the printer.

At 52, original documents are received by the printer 10 (FIG. 1). The original documents can be received via the document feeder 18 (FIG. 1) that delivers the original documents to the image reading device 24 (FIG. 1) to be scanned into a memory located in the printer. Alternatively, electronic documents, for example documents that are created by a computer program that can be delivered to a printer or computer or other device, can be received by the printer 10. For the sake of brevity, these electronic documents will also be referred to as original documents, where one document equates to one printed page of the electronic document.

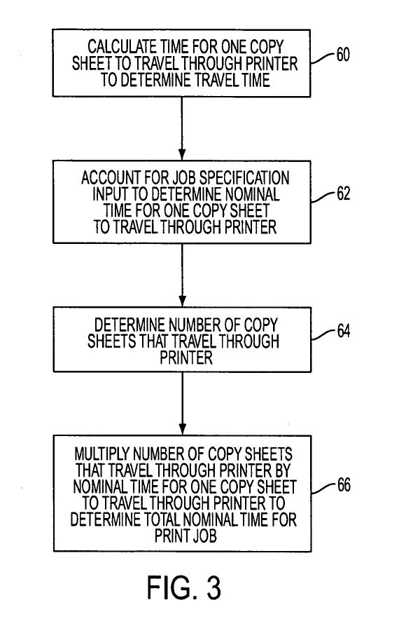

At 58, the nominal total time for the print job is calculated. With reference to FIG. 3, at 60, the time for one copy sheet to travel through the media transport system of the printer is calculated, i.e. travel time for one copy sheet, by summing the times for a copy sheet to travel between adjacent sensors along the media transport system. The time travel calculation can be based on determinations made by the jam detection system 36 (FIG. 1). Alternatively, the time travel can be input as a known time, for example the processor 16 (FIG. 1) can be programmed to include known travel times. At 62, any additional time is added to the travel time for a copy sheet based on the job specification input to determine a nominal time for one copy sheet to travel through the printer. At 64, the number of copy sheets that are to travel through the printer 10 (FIG. 1) for the print job is determined. The number of copy sheets is a function of the number of original documents and the number of copies desired in the job specification input. At 66, the nominal time for one copy sheet to travel through the printer 10 (FIG. 1) is then multiplied by the total number of copy sheets that are to be produced by the print job to determine the total time for the print job.

For example, if three originals are to be stapled and collated into three packets, then nine copy sheets are to travel through the printer. The travel time for one sheet is known, for example due to calculations performed by the jam detection system. Additional time is added to account for stapling and collating to arrive at a nominal time for one sheet to travel through the printer. This nominal time is then multiplied by nine to determine the total nominal time for the print job. Alternatively, the travel time for one sheet can be determined without accounting for stapling. The travel time is then multiplied by the number of copy sheets that will travel through the printer, which in this example is nine, and then additional time is added to account for stapling and collating.

With reference back to FIG. 2, at 68, the nominal time remaining for the print job is initialized based on the nominal total time calculated for the print job. At 70, the time remaining for the print job, which at first equals the nominal total time for the print job, is displayed on the display 20 (FIG. 1) of the printer. The time remaining for the print job can be displayed as minutes and seconds on the display 20. At 72, condition codes are checked, such as those that are developed by the system status module 34 (FIG. 1) to check for condition codes that would impact the print job. If condition codes are present that would impact the print job, then the condition code, for example a paper jam, low toner, and the like, is displayed, at 74, on the display 20 (FIG. 1) of the printer 10 (FIG. 1). The display 20 (FIG. 1) can continue to display the time remaining for the print job, at 70, until the condition code that would impact the print job is no longer present. If no condition codes are present that would impact the print job, at 76, the time remaining for the print job is counted down. At 78, the time remaining is checked to determine whether the time remaining equals zero. If the time remaining does not equal zero then the time remaining is displayed for the print job at 70. If the time remaining for the print job does equal zero then the sequence ends at 82.

The method for displaying an amount of time remaining for a print job has been described with reference to a particular order; however, the steps need not be provided in exactly the same order as described. For example, the time for one sheet to travel through the printer based on the user input can be performed before the original sheets have been received by the printer.

It will be appreciated that various of the above-disclosed and other features and functions, or alternatives thereof, may be desirably combined into many other different system or applications. Various presently unforeseen or unanticipated alternatives, modifications, variations, or improvements therein may be subsequently made by those skilled in the art which are also intended to be encompassed by the following claims.

1. In a printer, a method for displaying an amount of time remaining for a print job, the method comprising:
determining a time remaining for a print job; and
displaying the time remaining for the print job on a display of a printer.

2. The method of claim 1, wherein determining further comprises calculating a time for a sheet to travel through the printer.

3. The method of claim 2, wherein determining further comprises calculating a total time for the print job based on a number of original sheets that are received into the printer.

4. The method of claim 3, wherein determining further comprises calculating a total time for the print job based on the time for a sheet to travel through the printer and the desired number of sheets to be produced by the copy job.

5. The method of claim 2, wherein determining further comprises calculating a time for the sheet to travel through the printer based on print job specifications.

6. The method of claim 5, wherein determining further comprises calculating a time for the sheet to travel through the printer based on user input.

7. The method of claim 1, wherein determining further comprises counting down from the time remaining for the print job, whereby the time remaining is updated.

8. The method of claim 7, further comprising returning to displaying after counting down and updating the time remaining.

9. The method of claim 1, further comprising checking for condition codes that would impact the print job.

10. In a printer, a method for displaying an amount of time remaining for a print job, the method comprising:
receiving job specification input for a print job to be performed by the printer;
receiving a number of original documents into the printer;
determining a number of copy sheets that are to travel through the printer based on the job specification input and the number of original documents received by the printer;
calculating a time for a copy sheet to travel through the printer based on the job specification input;
calculating a total time for the print job based on the time calculated for the copy sheet to travel through the printer and the number of copy sheets that are to travel through the printer;
initializing time remaining from the total time;
displaying the time remaining on a display of the printer; and
counting down the time remaining, whereby the time remaining is updated.

11. The method of claim 10, wherein receiving original documents further comprises scanning the original sheets into a memory of the printer.

12. The method of claim 10, wherein calculating a time for a copy document is performed before receiving a number of original documents.

13. The method of claim 10, further comprising checking for a condition that impacts the print job.

14. The method of claim 13, wherein the condition includes conditions from a group comprising at least one of paper jams, low toner warnings, low paper warnings, out of staple faults and output tray full status.

15. The method of claim 10, further comprising displaying the updated time remaining and returning to displaying the time remaining.

16. The method of claim 10, wherein the printer comprises a copier.

17. The method of claim 10, wherein receiving a number of original documents comprises receiving electronic documents.

18. A printer comprising:
a printing module;
a processor; and
a time remaining display in communication with the processor.

19. The printer of claim 18, further comprising a jam detection system configured to detect a copy sheet as the copy sheet travels through the printer, wherein the processor is in communication with the jam detection system and is configured to determine a total time for a copy job based at least in part on information received by the jam detection system.

20. The printer of claim 19, further comprising a system status module in communication with the processor.
